(19) United States
(12) Patent Application Publication
(10) Pub. No.: US 2026/0264168 A1
(43) Pub. Date: Sep. 10, 2026

(54) METHOD AND DEVICE FOR MONITORING AND CONTROLLING LASER MACHINING PROCESSES

(71) Applicant: TRUMPF Laser SE, Schramberg (DE)

(72) Inventors: Andreas Jahn, Dornhan (DE); Rainer Thieringer, Bösingen (DE); Julia Ziegler, Albstadt (DE)

(21) Appl. No.: 19/661,736

(22) Filed: Apr. 29, 2026

Related U.S. Application Data
(63) Continuation of application No. PCT/EP2024/080455, filed on Oct. 28, 2024.

(30) Foreign Application Priority Data
Nov. 3, 2023 (DE) 10 2023 130 468.2

(51) Int. Cl. B23K 26/046; B23K 26/03; B23K 26/04

(52) U.S. Cl. CPC B23K 26/046; B23K 26/03; B23K 26/04

(57) ABSTRACT

A method for monitoring and controlling a laser machining process on a workpiece includes generating a recording of an environment of a process zone generated by a machining laser beam in the workpiece using an image recording device, removing interference factors in the recording using an artificial intelligence method in an image processing device, detecting geometric workpiece properties based on the recording that is free of the interference factors using the artificial intelligence method, generating an input signal for a downstream image processing algorithm from the recording that is free of the interference factors and containing information of the geometric workpiece properties, and determining a correction value for at least one control parameter for a path of the machining laser beam over the workpiece using the image processing algorithm.

### CROSS REFERENCE TO RELATED APPLICATIONS

This application is a continuation of International Application No. PCT/EP2024/080455 (WO 2025/093494A1 ), filed on Oct. 28, 2024, and claims benefit to German Patent Application No. DE 10 2023 130 468.2, filed on Nov. 3, 2023. The aforementioned applications are hereby incorporated by reference herein.

### FIELD

When laser machining workpieces, the correct alignment of the machining laser beam relative to the workpiece is crucial for high-quality machining. Therefore, various monitoring and control systems with sensors for object recognition and distance measurement between the optical focusing system of the machining laser beam and the workpiece are used in laser machining systems.

### BACKGROUND

Using a line laser positioned in front of the machining laser beam and a camera which captures both the reflections of the line laser beam and the process zone generated by the machining laser beam in the workpiece, distance measurements can be carried out and height differences in the workpiece can also be detected using an image processing device. Laser welding thus makes it possible to detect the transition from a top sheet to a bottom sheet and to guide the machining laser along this transition line, so that a precise welding seam is created. However, this solution is limited to monitoring in the feed direction of the machining laser beam.

In contrast, when an OCT scanner is used for monitoring, the image recording enables the detection of height differences in the workpiece and distance measurements in all spatial directions, independent of the feed direction of the machining laser. However, this monitoring system is relatively complex and expensive due to the use of an OCT scanner.

From EP 2 365 890 B1, a monitoring system for a laser machining system is known which includes an OCT scanner, a camera with HDR functions, and an image processing device. The camera takes a plurality of recordings of the process zone with different exposure times and calculates images with a high contrast ratio therefrom, which are then supplied as measurement values to the image processing device. This compares the measured values with key values determined through a data reduction process. Alternatively, the parameters can also be calculated using a neural network. The determined parameters allow for a classification of the laser machining process. Furthermore, it is possible to readjust the path and/or the distance of the machining laser to the workpiece based on the determined parameters.

### SUMMARY

Embodiments of the present invention provide a method for monitoring and controlling a laser machining process on a workpiece. The method includes generating a recording of an environment of a process zone generated by a machining laser beam in the workpiece using an image recording device, and removing interference factors in the recording using an artificial intelligence method in an image processing device. The interference factors include at least one of process light, soot, or material splashes. The method further includes detecting geometric workpiece properties based on the recording that is free of the interference factors using the artificial intelligence method. The geometric workpiece properties include at least one of workpiece edges or height changes. The method further includes generating an input signal for a downstream image processing algorithm from the recording that is free of the interference factors and containing information of the geometric workpiece properties, and determining a correction value for at least one control parameter for a path of the machining laser beam over the workpiece using the image processing algorithm.

### BRIEF DESCRIPTION OF THE DRAWINGS

Subject matter of the present disclosure will be described in even greater detail below based on the exemplary figures. All features described and/or illustrated herein can be used alone or combined in different combinations. The features and advantages of various embodiments will become apparent by reading the following detailed description with reference to the attached drawings, which illustrate the following:

FIG. 1 shows a schematic block diagram of a machining head 10 and an image processing device 11 of a laser machining system (not shown further) according to some embodiments.

### DETAILED DESCRIPTION

Embodiments of the invention provide a method to monitor and control a laser machining process using structurally simple means.

According to embodiments of the invention, a method for monitoring and controlling laser machining processes on a workpiece, the method having the following steps:
recording the environment of a process zone generated by a machining laser beam in a workpiece using an image recording device;
eliminating interference factors in the recording such as process lights, soot, or material splashes using an artificial intelligence method in an image processing device;
detecting geometric workpiece properties such as workpiece edges and/or height changes in the recording using the artificial intelligence method;
generating an input signal for a downstream image processing algorithm from the recording cleaned of interference factors and containing information about the geometric workpiece properties using the artificial intelligence method;
calculating a correction value for at least one control parameter for the path of the machining laser beam over the workpiece using the image processing algorithm.

The method according to embodiments of the invention allows monitoring and control of the path of a machining laser beam using only a few devices, which are also usually already present on the machining heads of laser machining systems. No additional line lasers or OCT scanners are required. The process light from the laser machining process can be used as indirect lighting for the recordings.

The monitoring and control according to embodiments of the invention is independent of the feed direction of the machining laser beam, so that seam position control can be performed for more complex welding seam geometries, in particular for laser welding processes.

The artificial intelligence method also allows for continuous improvement of the pre-processing of the recordings of the process zone, so that the method according to embodiments of the invention can reach a robust conclusion about the position of the machining laser beam relative to workpiece edges, weld seams and other elements of the workpiece. By pre-processing the recordings of the process zone and its surroundings, an input signal can be provided to the actual image processing algorithm that is free from all interference factors. From this input signal, the image processing algorithm can detect the geometric properties of interest of the workpiece, such as a height step, and calculate a correction value for at least one control parameter of the path of the machining laser beam. The parameterization of the image processing algorithm can be chosen more easily than with methods according to the prior art.

Further advantages arise when not only are interference factors in the recordings eliminated using artificial intelligence, but also artificial intelligence method amplifies the information about the geometric workpiece properties in the input signal for the image processing algorithm. This allows the image processing algorithm to recognize these workpiece properties with greater certainty and, if necessary, generate corresponding correction values for the control parameters of the laser path.

It is further advantageous that the parameters of the image processing algorithm do not need to be changed by the processed input signal, as is the case with methods according to the prior art. Pre-processing the recordings makes it possible to keep the parameters of the image processing algorithm constant by ensuring the uniqueness of the information in the input signal. In this case, the parameterization can also be significantly simpler than with the known methods.

Further amplification of the input signal can be achieved by using the image recording device to generate a plurality of recordings with different exposure times and combine them using a high dynamic range (HDR) method to generate an image with a high contrast value, from which the interference factors are eliminated and the geometric workpiece properties are detected using the artificial intelligence method.

The recordings are preferably taken coaxially with the machining laser beam using the image recording device.

The robustness of the method can also be increased by having the artificial intelligence method take into account information about the shape of the workpiece and the path of the laser beam when the recording of the process zone is pre-processed. In this way, the AI method can restrict the search space for interference factors and geometric workpiece properties of interest in the recordings.

The artificial intelligence method can preferably be used to calculate a single-layer or multi-layer neural network for the detection of interference factors and geometric workpiece properties. However, the AI method can also be based on other methods such as linear regression, etc.

The method according to embodiments of the invention can be used in all laser machining processes. However, particular advantages arise when it is a method for monitoring and controlling a laser welding process. In these processes, precise detection of the joining line between two workpieces is essential. If a top sheet is welded to a bottom sheet, the joining line can be detected by a change in height in the workpiece.

Embodiments of the invention also relate to a device for carrying out a method according to embodiments of the invention for monitoring and controlling laser machining processes on a workpiece, which device has an image recording device arranged coaxially with a machining laser beam of a laser machining system and an image processing device, characterized in that the image processing device is designed such that it performs a pre-processing of the recording from the image recording device using a method based on artificial intelligence, with which interference factors in the recording are removed and information about geometric properties of the workpiece which are essential for the machining process is amplified, before subjecting the pre-processed recording to an image processing algorithm and generating therefrom control parameters for the path of the machining laser beam.

The process light from the laser machining process can be used as indirect lighting for the recordings. However, providing additional lighting sources is also possible.

The image processing device can preferably calculate a neural network for the artificial intelligence method and the image processing algorithm, to which the recordings are subjected. In this way, adaptation to new workpieces can be achieved.

The image recording device can advantageously be a camera with HDR functions.

The device can also be retrofitted relatively easily to existing laser machining systems.

Embodiments of the invention also provide a machining head for a laser machining system, which has a device according to embodiments of the invention.

In the following, a preferred exemplary embodiment of a device will be explained in more detail with reference to the drawing.

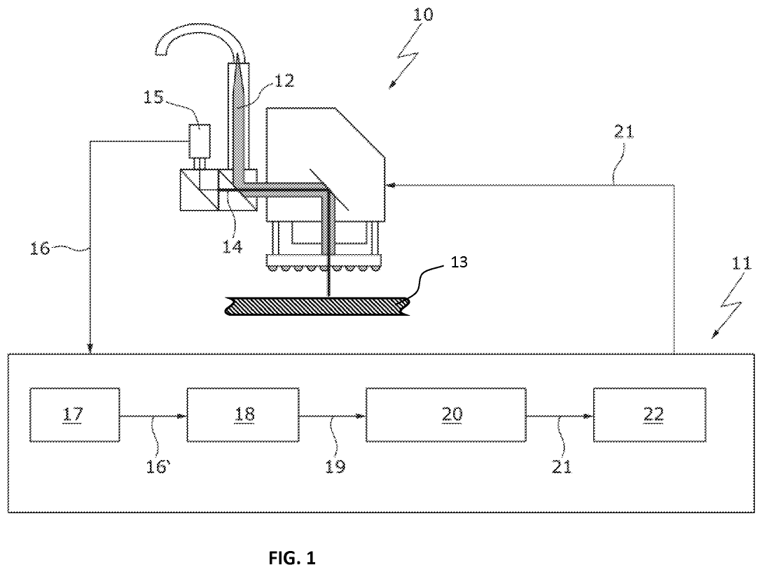

FIG. 1 shows a schematic block diagram of a machining head 10 and an image processing device 11 of a laser machining system (not shown further). The machining head 10 directs a machining laser beam 12 onto a workpiece 13. The light 14 reflected from the workpiece 12 is detected by an image recording device 15, preferably an HDR camera, by means of recordings 16 which are forwarded to the image processing device 11.

In the image processing device 11, the recordings 16 from the image recording device 15 are prepared 17, in which interference factors such as reflections from splashes, soot or process lights are eliminated from the recordings 16 by means of an artificial intelligence method. The prepared recordings 16′ are then subjected to further processing 18, in which workpiece edges, height changes and other geometric workpiece properties are recognized in the recordings by the artificial intelligence process. This generates an input signal 19 for an image processing algorithm 20, which uses these signals 19, which contain the recordings 16′ freed from interference factors with amplified information about the geometric workpiece properties, to generate control signals 21 for the machining head 10. These control signals 21 are subjected to a further error control 22 before being forwarded to the machining head 10. The control signals 21 can be used in particular to make corrections to the optical axis of the machining head 10.

While subject matter of the present disclosure has been illustrated and described in detail in the drawings and foregoing description, such illustration and description are to be considered illustrative or exemplary and not restrictive. Any statement made herein characterizing the invention is also to be considered illustrative or exemplary and not restrictive as the invention is defined by the claims. It will be understood that changes and modifications may be made, by those of ordinary skill in the art, within the scope of the following claims, which may include any combination of features from different embodiments described above.

The terms used in the claims should be construed to have the broadest reasonable interpretation consistent with the foregoing description. For example, the use of the article “a” or “the” in introducing an element should not be interpreted as being exclusive of a plurality of elements. Likewise, the recitation of “or” should be interpreted as being inclusive, such that the recitation of “A or B” is not exclusive of “A and B,” unless it is clear from the context or the foregoing description that only one of A and B is intended. Further, the recitation of “at least one of A, B and C” should be interpreted as one or more of a group of elements consisting of A, B and C, and should not be interpreted as requiring at least one of each of the listed elements A, B and C, regardless of whether A, B and C are related as categories or otherwise. Moreover, the recitation of “A, B and/or C” or “at least one of A, B or C” should be interpreted as including any singular entity from the listed elements, e.g., A, any subset from the listed elements, e.g., A and B, or the entire list of elements A, B and C.

### LIST OF REFERENCE SIGNS

10 Machining head
11 Image processing device
12 Machining laser beam
13 Workpiece
14 Reflected light
15 Image recording device
16, 16′ Recording
17 Preparation
18 Processing
19 Input signal
20 Image processing algorithm
21 Control parameter
22 Error control

1. A method for monitoring and controlling a laser machining process on a workpiece, the method comprising:
generating a recording of an environment of a process zone generated by a machining laser beam in the workpiece using an image recording device;
removing interference factors in the recording using an artificial intelligence method in an image processing device, the interference factors comprising at least one of process light, soot, or material splashes;
detecting geometric workpiece properties based on the recording that is free of the interference factors using the artificial intelligence method, the geometric workpiece properties comprising at least one of workpiece edges or height changes;
generating an input signal for a downstream image processing algorithm from the recording that is free of the interference factors and containing information of the geometric workpiece properties; and
determining a correction value for at least one control parameter for a path of the machining laser beam over the workpiece using the image processing algorithm.

2. The method according to claim 1, wherein the process light of the laser machining process is used as indirect lighting for the recording.

3. The method according to claim 1, wherein the artificial intelligence method amplifies the information of the geometric workpiece properties in the input signal for the image processing algorithm.

4. The method according to claim 1, wherein parameters of the image processing algorithm are not changed by the input signal.

5. The method according to claim 1, wherein a plurality of recordings with different exposure times are generated with the image recording device, wherein the plurality of recordings are combined using a high dynamic range method to generate an image with a high contrast value, from which the interference factors are removed and the geometric workpiece properties are detected using the artificial intelligence method.

6. The method according to claim 1, wherein the recording is taken with the image recording device coaxially to the machining laser beam.

7. The method according to claim 1, wherein the artificial intelligence method takes into account information about a shape of the workpiece and the path of the machining laser beam while the recording of the process zone is pre-processed.

8. The method according to claim 1, wherein at least one neural network is generated for recognizing the interference factors and the geometric workpiece properties using the artificial intelligence method.

9. The method according to claim 1, wherein the laser machining process is a laser welding process.

10. A device for carrying out a method for monitoring and controlling a laser machining process on a workpiece according to claim 1, the device comprising:
the image recording device arranged coaxially with the machining laser beam of a laser machining system, and
the image processing device, wherein the image processing device is configured to perform a pre-processing of the recording from the image recording device using the artificial intelligence method to remove the interference factors in the recording and amplify information about geometric properties of the workpiece, before applying the image processing algorithm and the determining the correction value for the at least one control parameter for the path of the machining laser beam.

11. The device according to claim 10, wherein the image processing device is configured to generate a neural network for the artificial intelligence method and the image processing algorithm.

12. The device according to claim 10, wherein the image recording device comprises a camera with HDR functions.

13. The device according to claim 10, wherein the device is configured to be retrofitted to existing laser machining systems.

14. A machining head for a laser machining system, the machining head comprising a device according to claim 10.
